(19) United States
(12) Patent Application Publication
(10) Pub. No.: US 2018/0128957 A1
(43) Pub. Date: May 10, 2018

(54) GLASS ARTICLE COMPRISING LIGHT EXTRACTION FEATURES AND METHODS FOR MAKING THE SAME

(71) Applicant: CORNING INCORPORATED, CORNING, NY (US)

(72) Inventors: Brian Douglas Davis, Lindley, NY (US); Jacques Gollier, Redmond, VA (US); Vasudha Ravichandran, Painted Post, NY (US); Christine Coulter Wolcott, Horseheads, NY (US)

(21) Appl. No.: 15/574,260

(22) PCT Filed: May 12, 2016
(86) PCT No.: PCT/US16/31960

§ 371 Date: Nov. 15, 2017

Related U.S. Application Data
(60) Provisional application No. 62/162,252, filed on May 15, 2015.

(51) Int. Cl. F21V 8/00; C03C 15/00; C03C 23/00; C03C 17/00

(52) U.S. Cl. CPC G02B 6/0036; G02B 6/0065; G02B 6/0061; C03C 2218/32; C03C 23/0075; C03C 17/002; C03C 2218/119; C03C 15/00

(57) ABSTRACT

Disclosed herein are glass articles, such as light guide plates, comprising a first surface (101) and an opposing second surface (102), wherein the first surface comprises an array of light extraction features (103) having a diameter of at least about 10 microns and a height ranging from about 1 micron to about 10 microns. Display devices comprising such glass articles are also disclosed herein as well as methods for producing such glass articles. The method involves depositing ink on a first surface of a glass substrate to form an array of coated and uncoated surfaces and etching the uncoated surfaces.

### CROSS-REFERENCE TO RELATED APPLICATIONS

This application claims the benefit of priority under 35 U.S.C. § 119 of U.S. Provisional Application Ser. No. 62/162,252 filed on May 15, 2015, the content of which is relied upon and incorporated herein by reference in its entirety.

### FIELD OF THE DISCLOSURE

The disclosure relates generally to glass articles and display devices comprising such articles, and more particularly to glass articles comprising light extraction features which reduce color shifting and methods for making the same.

### BACKGROUND

Liquid crystal displays (LCDs) are commonly used in various electronics, such as cell phones, laptops, electronic tablets, televisions, and computer monitors. Increased demand for larger, high-resolution flat panel displays drives the need for large high-quality glass substrates for use in the display. For example, glass substrates may be used as light guide plates (LGPs) in LCDs, to which a light source may be coupled. A common LCD configuration for thinner displays includes a light source optically coupled to an edge of the light guide. Light guide plates are often equipped with light extraction features on one or more surfaces to scatter light as it travels along the length of the light guide, thereby causing a portion of the light to escape the light guide and project toward the viewer. Engineering of such light extraction features to improve homogeneity of light scattering along the length of the light guide has been studied in an effort to generate higher quality projected images.

Currently, light guide plates can be constructed from plastic materials having high transmission properties, such as polymethyl methacrylate (PMMA) or methyl methacrylate styrene (MS). However, due to their relatively weak mechanical strength, it can be difficult to make light guides from PMMA or MS that are both sufficiently large and thin to meet current consumer demands. Glass light guides have been proposed as alternatives to plastic light guides due to their low light attenuation, low coefficient of thermal expansion, and high mechanical strength.

Methods for providing light extraction features on plastic materials can include, for example, injection molding and laser damaging to produce features having a diameter of less than about 0.1 mm. While these techniques may work well with plastic light guides, injection molding can be incompatible with glass light guides and laser exposure may be incompatible with glass reliability, e.g., may promote chipping, crack propagation, and/or sheet rupture.

Alternative methods for applying light extraction features to glass light guides can include printing techniques such screen printing or inkjet printing. However, printing light extraction features on glass may present other challenges. Specifically, inkjet printing can comprise a step of curing the ink using UV B or UV C light, which may cause solarization of the glass, resulting in glass absorption and/or color shift. Screen printing can similarly comprise a curing step, in which ink is cured using heat, e.g., IR curing. While heat curing may eliminate issues caused by solarization, IR curable ink can also generate significant color shift for a glass light guide (e.g., a dy of at least 0.02 to 0.03 in the CIE chromaticity diagram for a 65-inch (165 cm) diagonal display panel). In addition, inkjet and screen printing methods may result in image artifacts such as high frequency noise (“mura”).

Accordingly, it would be advantageous to provide glass articles, such as light guide plates, for display devices which address the aforementioned drawbacks, e.g., glass light guide plates having light extraction features which provide enhanced image quality and reduced color shifting.

### SUMMARY

The disclosure relates, in various embodiments, to a glass article comprising a first surface and an opposing second surface, wherein the first surface comprises an array of light extraction features having a diameter of at least about 10 microns and a height ranging from about 1 micron to about 10 microns.

Methods for making such glass articles are also disclosed, the methods comprising depositing ink on a first surface of a glass substrate to form an array of coated and uncoated surfaces. The uncoated surfaces can then be etched to form a glass article having a first surface comprising an array of light extraction features having a diameter of at least about 10 microns and a height ranging from about 1 micron to about 10 microns.

In a first embodiment, an array of substantially convex light extraction features can be formed by depositing ink on the first surface to form an array of discontinuous ink features, wherein each discontinuous ink feature is surrounded by an uncoated surface. In a second embodiment, an array of substantially concave light extraction features can be formed by depositing ink on the first surface to form an array of discontinuous uncoated surfaces, wherein each discontinuous uncoated surface is surrounded by a coated surface.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

The following detailed description can be further understood when read in conjunction with the following drawings where, when possible, like numerals refer to like components, it being understood that the appended figures are not necessarily drawn to scale.

FIG. 1 illustrates a glass article comprising an array of light extraction features according to embodiments of the disclosure;

FIG. 2 illustrates a cross-sectional view of a glass article comprising an array of convex light extraction features according to certain embodiments of the disclosure;

FIG. 3 illustrates a cross-sectional view of a glass article comprising an array of concave light extraction features according to other embodiments of the disclosure;

FIG. 4 is a plot of the blue/red scattering efficiency ratio as a function of RMS surface roughness;

FIGS. 5A-B illustrate a method for producing a glass article comprising an array of convex light extraction features according to embodiments of the disclosure;

FIG. 6 depicts the surface of a glass substrate having a high-frequency texture;

FIG. 7A-C illustrate glass articles comprising arrays of convex light extracting features formed using inks having varying adhesion to the glass article; and

FIGS. 8A-B illustrate a method for producing a glass article comprising an array of concave light extraction features.

### DETAILED DESCRIPTION

Glass Articles

Disclosed herein are glass articles comprising a first surface and an opposing second surface; the first surface comprising an array of light extraction features having a diameter of at least about 10 microns and a height ranging from about 1 micron to about 10 microns.

As used herein, the term “convex” is intended to denote a light extraction feature whose surface curves out or extends outward from the surface of the glass article, e.g., a semi-spherical or semi-ellipsoidal shape. The light extraction feature can be envisioned as a rounded dome positioned on the surface of the glass article, the dimensions of which need not be perfectly rounded, semi-spherical, or semi-ellipsoidal.

As used herein, the term “concave” is intended to denote a light extraction feature whose surface curves downward below the surrounding surface of the glass article, e.g., a semi-spherical or semi-ellipsoidal shape. The light extraction feature can be envisioned as a rounded crater positioned on the surface of the glass article, the dimensions of which need not be perfectly rounded, semi-spherical, or semi-ellipsoidal.

The glass article may comprise any material known in the art for use as in displays or similar devices including, but not limited to, aluminosilicate, alkali-aluminosilicate, borosilicate, alkali-borosilicate, aluminoborosilicate, alkali-aluminoborosilicate, soda lime, and other suitable glasses. In certain embodiments, the glass article may comprise a glass sheet having a thickness of less than or equal to about 3 mm, for example, ranging from about 0.3 mm to about 2 mm, from about 0.7 mm to about 1.5 mm, or from about 1.5 mm to about 2.5 mm, including all ranges and subranges therebetween. Non-limiting examples of commercially available glasses suitable for use as a light guide plate include, for instance, EAGLE XG®, Iris™, Lotus™, Willow®, and Gorilla® glasses from Corning Incorporated.

The glass article may comprise a first surface and an opposing second surface. The surfaces may, in certain embodiments, be planar or substantially planar, e.g., substantially flat and/or level. The first and second surfaces may, in various embodiments, be parallel or substantially parallel. The glass article may further comprise at least one side edge, for instance, at least two side edges, at least three side edges, or at least four side edges. By way of a non-limiting example, the glass article may comprise a rectangular or square glass sheet having four edges, although other shapes and configurations are envisioned and are intended to fall within the scope of the disclosure.

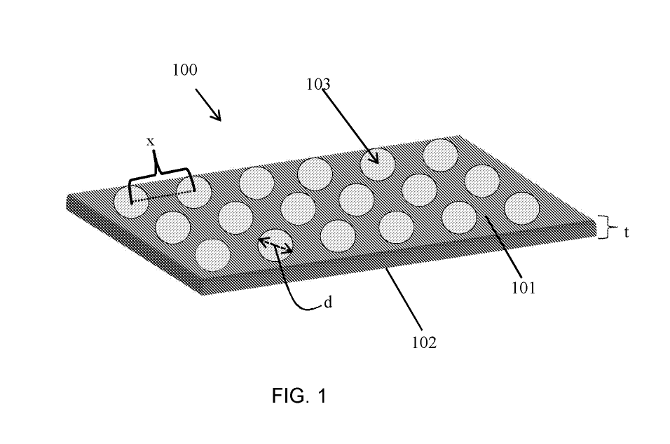

As illustrated in FIG. 1, the glass article 100 (e.g., glass light guide plate) can have a first surface 101, an opposing second surface 102, and a thickness t extending therebetween, wherein the first surface comprises an array of light extraction features 103 having a diameter d and a spacing x between each light extraction feature. As discussed above, the thickness t of the glass article can range from about 0.3 mm to about 3 mm. While FIG. 1 depicts the first surface 101 of the glass article as comprising an array of light extraction features, it is to be understood that the second surface 102 can likewise comprise an array of light extraction features, or both surfaces can comprise such features, which can independently have any shape and/or orientation, as discussed in further detail below.

The array of light extraction features 103 can, in certain embodiments, be arranged in a pattern, such as in one or more rows or columns. While FIG. 1 depicts 18 light extraction features arranged in 3 columns and 6 rows, any number of rows, columns, or light extraction features is possible and envisioned. The depicted use of rows and columns of light extraction features is not intended to be limiting and the array may comprise light extraction features present on the surface of the glass article in any given pattern which may for example, be random or arranged, repetitive or non-repetitive, or symmetrical or asymmetrical. Of course other arrangements can be provided and are intended to fall within the scope of the disclosure.

In certain embodiments the light extraction features can have a diameter d of at least about 10 microns. The diameter d can range, for example, from about 10 microns to about 700 microns, such as from about 15 microns to about 600 microns, from about 20 microns to about 500 microns, from about 25 microns to about 400 microns, from about 30 microns to about 300 microns, from about 40 microns to about 200 microns, or from about 50 microns to about 100 microns, including all ranges and subranges therebetween. According to various embodiments, the diameter d of each light extraction feature can be identical to or different from the diameter d of other light extraction features in the array.

The distance between light extraction features can be defined as a distance x between the centers of two adjacent light extraction features 103. In some embodiments, the distance x can range from about 5 microns to about 2 mm, such as from about 10 microns to about 1.5 mm, from about 20 microns to about 1 mm, from about 30 microns to about 0.5 mm, or from about 50 microns to about 0.1 mm, including all ranges and subranges therebetween. It is to be understood that the distance x between each light extraction feature can vary in the array, with different extraction features spaced apart from one another at varying distances x.

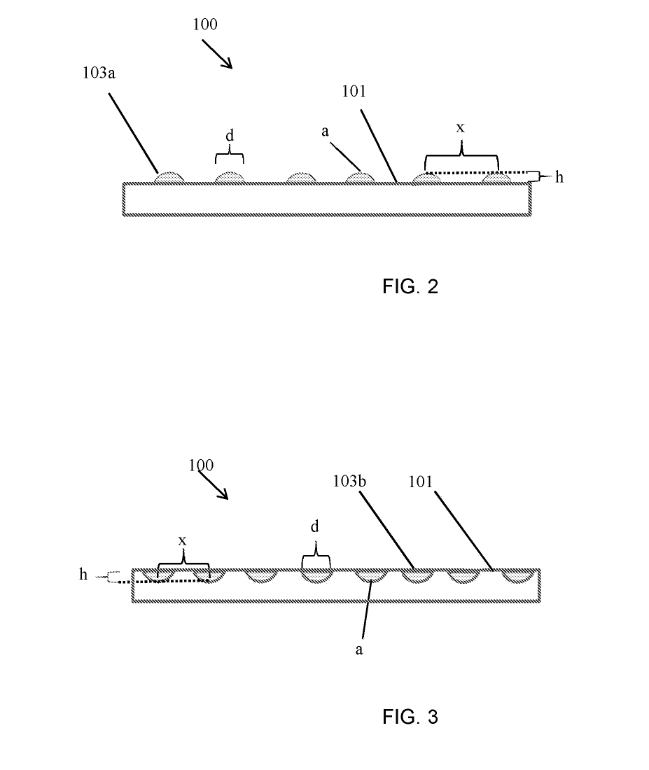

According to various embodiments, and as illustrated in FIGS. 2-3, the array of light extraction features can comprise a plurality of light extraction features, which can be substantially convex or concave. FIG. 2 depicts a cross-sectional view of a glass article 100 comprising convex light extraction features 103a which extend outward from the first surface 101 of the glass article 100. While depicted as semi-spherical, the convex light extraction features 103a need not be perfectly rounded, semi-spherical, or semi-ellipsoidal and can have any convex shape as defined herein. For example, the light extraction features 103a may be ellipsoidal, paraboloidal, hyperboloidal, frusto-conical, or any other suitable geometry, and any of these features may be random or arranged, repetitive or non-repetitive, or symmetrical or asymmetrical. In some embodiments, light extraction features 103a on some portions of the glass article 100 may have a first geometry while light extraction features 103a on other portions of the glass article 100 may have a second geometry. For example, light extraction features 103a on portions of a glass article 100 (such as a light guide plate) adjacent or near the edges thereof or adjacent or near portions that receive light from a source (not shown) may have a first geometry and light extraction features 103a near the center of the glass article 100 or a predetermined distance from the light source may have a second geometry.

The convex light extraction features comprise a height h and a diameter d. As described above, the diameter d can be at least about 10 microns, for example, ranging from about 10 microns to about 700 microns. The convex light extraction features can also have a height h, measured as the distance from the first surface to the apex a (or highest point) of the light extraction feature. The height h can range, in various embodiments, from about 1 micron to about 10 microns, such as from about 2 microns to about 9 microns, from about 3 microns to about 8 microns, from about 4 microns to about 7 microns, or from about 5 microns to about 6 microns, including all ranges and subranges therebetween. According to additional embodiments, a ratio d:h can be at least about 1:1. In some embodiments the ratio d:h can range from about 1:1 to about 500:1, such as from about 2:1 to about 400:1, from about 3:1 to about 300:1, from about 4:1 to about 200:1, from about 5:1 to about 100:1, or from about 10:1 to about 50:1, including all ranges and subranges therebetween. The convex light extraction features can have an apex a, and the distance x between light extraction features can be defined as the distance between the apexes of two adjacent convex light extraction features 103a. As described above, the distance x can range from about 5 microns to about 2 mm.

In some embodiments, light extraction features 103a on some portions of the glass article 100 (e.g., a glass light guide plate) may have a height or ratio d:h while light extraction features 103a on other portions of the glass article 100 may have a second height or ratio d:h. For example, light extraction features 103a on portions of the glass article 100 (such as a light guide plate) adjacent or near the edges thereof or adjacent or near portions that receive light from a source (not shown) may have a first height or ratio d:h and light extraction features 103a near the center of the glass article 100 or a predetermined distance from the light source may have a second height or ratio d:h. In other embodiments, heights, ratios, and/or geometries of the light extraction features 103a may vary as a function of position on the surface of the glass article 100.

FIG. 3 depicts a cross-sectional view of a glass article 100 comprising concave light extraction features 103b, which extend inward from the first surface 101 of the glass article 100. While depicted as semi-spherical, the concave light extraction features 103b need not be perfectly rounded, semi-spherical, or semi-ellipsoidal and can have any concave shape as defined herein. Of course, the light extraction features 103b may also be concave-ellipsoidal, -paraboloidal, -hyperboloidal, -frusto-conical, or any other suitable geometry, and any of these features may be random or arranged, repetitive or non-repetitive, or symmetrical or asymmetrical. The concave light extraction features 103b comprise a height (or depth) h, measured as the distance from the first surface to the apex a (or lowest point) of the light extraction feature, and a diameter d, which can be similar to those described above for the convex light extraction features 103a of FIG. 2. Similarly, the distance x between light extraction features can be measured as a distance between the apexes of two adjacent concave light extraction features and can have values similar to those provided above with respect to FIG. 2.

Similar to the description of FIG. 2, light extraction features 103b on some portions of the glass article 100 (e.g., glass light guide plate) may have a height h or ratio d:h while light extraction features 103b on other portions of the glass article 100 may have a second height or ratio d:h. Further, light extraction features 103b on some portions of the glass article 100 may have a first geometry while light extraction features 103b on other portions of the glass article 100 may have a second geometry. Thus, in exemplary embodiments, heights (depths), ratios, and/or geometries of the light extraction features 103b may vary as a function of position on the surface of the glass article 100 (such as a glass light guide plate).

According to various non-limiting embodiments, the diameter d and/or height h of the light extraction features, whether convex or concave, can be chosen to minimize wavelength-dependent scattering and/or color shifting. For example, by providing light extraction features having a larger diameter and a height (or depth) greater than the longest wavelength of light to be scattered (e.g., visible light), high-frequency textures on the surface of the glass article can be reduced or eliminated. As used herein, the term “high-frequency texture” is intended to include small features on the surface of the glass article having a diameter of about 5 microns or less (e.g., about 5, 4, 3, 2, or 1 microns, or less) and a shallow depth or height of less than about 0.7 microns, e.g., a depth or height less than the wavelength of light in the visible spectrum (˜400-700 nm).

High-frequency textures can produce surfaces with fine (e.g., small and shallow) roughness, which may lead to selective or wavelength-dependent scattering of light, thereby causing color shift. For example, scattering can be a function of wavelength and scattering efficiency can be high in the blue (shorter) wavelengths (˜400-500 nm) than in the red (longer) wavelengths (˜600-700 nm). For random surfaces having a roughness greater than the wavelength of light to be scattered, Fourier optics can be used to calculate diffraction efficiency using the following formula:

Eff=1−exp(−(2πδΔn/λ)²)

wherein Eff is the scattering efficiency (% of light scattered instead of reflected); δ is the RMS roughness value; Δn is the index contrast (about 3 in the case of a light guide plate in reflection mode with n=1.5); and λ is the wavelength. Using this formula, the ratio between scattering efficiency in the blue (˜440 nm) and red (˜640 nm) wavelengths can be calculated.

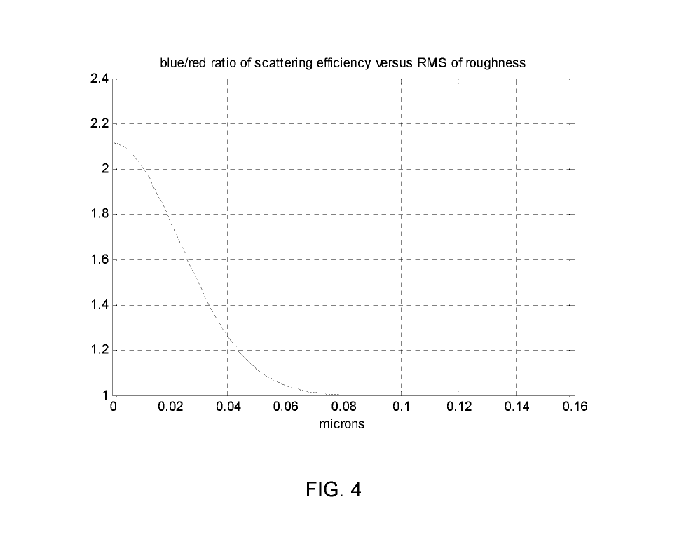

FIG. 4 is a graphical plot of the blue/red scattering efficiency ratio as a function of RMS roughness. According to the plot, to achieve negligible color shift, the RMS roughness of the glass surface should be at least about 0.07 microns. However, when light features with sizes smaller than the wavelength of light to be scattered are employed, other scattering modes are encountered, such as Rayleigh or Mie scattering, which can be highly wavelength-dependent (e.g., Rayleigh scattering efficiency is inversely proportional to the wavelength raised to the fourth power). Thus, the light extraction features according to various embodiments disclosed herein can be configured to have a height h and diameter d sufficient to reduce or eliminate high-frequency textures on the surface of the glass article, thereby reducing or eliminating undesirable color shift. In some embodiments, glass articles, such as light guide plates, disclosed herein can produce a color shift dy of less than about 0.01 in the CIE chromaticity diagram for a 65-inch (165 cm) diagonal display.

Methods

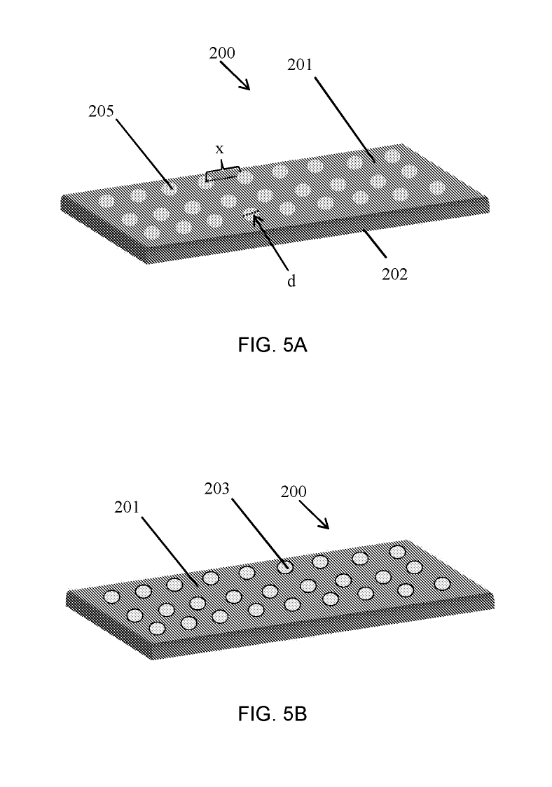

Disclosed herein are methods for making glass articles or light guide plates, the methods comprising depositing ink on a first surface of a glass substrate to form an array of coated and uncoated surfaces; and etching the uncoated surfaces to form a glass article comprising an array of light extraction features having a diameter of at least about 10 microns and a height ranging from about 1 micron to about 10 microns. A first method for producing a glass article having convex light extraction features as depicted in FIG. 2, will now be described with reference to FIGS. 5A-B.

With reference to FIG. 5A, a glass substrate 200 can be provided having a first surface 201 and an opposing second surface 202. In certain embodiments the glass substrate 200 can be subjected to a cleaning step to remove surface contaminants, such as molecular organic contaminants, from the glass substrate 200. Cleaning steps can, in some embodiments, be carried out using detergents such as Parker 225; SC-1; ozone; and/or oxygen plasma, to name a few. Cleaning of the glass substrate to remove molecular organic contaminants can, in some embodiments, improve the wettability of the ink applied in the subsequent ink-treating step.

As illustrated in FIG. 5A, ink can be deposited on the first surface 201 of the glass substrate 200 to provide an array of discontinuous ink features 205. As used herein the term “discontinuous” ink features is intended to denote that the ink applied to the glass substrate can comprise an array of separate or spaced-apart ink-covered portions which are not in contact with one another. According to various embodiments, the positioning of the discontinuous ink features can substantially correspond to the positioning of the convex light extraction features. The ink may be applied to the glass substrate using any known method including, but not limited to, ink jet and screen printing processes. The ink may comprise any ink known in the art which is sufficiently resistant to the etching process described below and which exhibit satisfactory adhesion to the glass substrate. For example, suitable inks can include, but are not limited to, inorganic materials chosen from titania, zirconia, ceria, zinc oxide, alumina, silica, sapphire, diamond, galium arsenide, germania, and combinations thereof or suitable organic materials.

In certain embodiments the discontinuous ink features comprise a rounded shape, e.g., circular or elliptical, however the dimensions need not be perfectly circular or perfectly elliptical. The rounded discontinuous ink features can be applied in a manner and/or amount suitable to obtain a diameter d of at least about 10 microns, such as from about 10 microns to about 700 microns, or any other range or subrange discussed above with respect to FIGS. 1-3. Similarly, the distance between the discontinuous ink features can be defined as a distance x between the centers of adjacent discontinuous ink features and can be chosen from values discussed above with respect to FIGS. 1-3.

While FIG. 5A depicts 27 discontinuous ink features arranged in 3 columns and 9 rows, any number of rows, columns, or discontinuous ink features is possible and envisioned. The depicted use of rows and columns of discontinuous ink features is not intended to be limiting and the array may comprise discontinuous ink features present on the surface of the glass substrate in any given pattern which may for example, be random or arranged, repetitive or non-repetitive, or symmetrical or asymmetrical. Of course other arrangements can be provided and are intended to fall within the scope of the disclosure.

After application of the ink, the glass substrate 200 comprising an array of discontinuous ink features 205 can be subjected to an etching step. Etching can be carried out using any process known in the art, for example, by immersion in or contact with an etching agent. According to various embodiments, the etching step can comprise immersing the glass substrate in an acid bath, such as hydrofluoric acid and/or hydrochloric acid or any other suitable mineral or inorganic acid. Suitable concentrations for the acid bath can range, for example from about 0.2 M to about 2 M, such as from about 0.4 M to about 1.8 M, from about 0.6 M to about 1.6 M, from about 0.8 M to about 1.4 M, or from about 1 M to about 1.2 M, including all ranges and subranges therebetween.

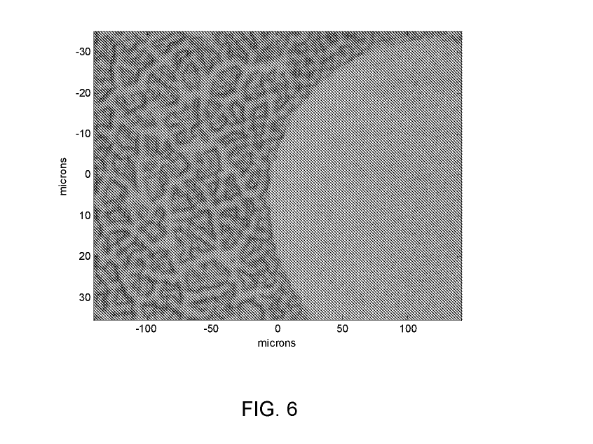

According to various embodiments, the etching agent may be chosen from agents that do not create high-frequency textures on the surface of the glass article. For example, organic etching agents can create insoluble crystals on the surface of the glass substrate, which can produce high-frequency textures on the surface of the glass substrate. An exemplary high-frequency texture is illustrated in FIG. 6, which depicts the surface of a glass substrate etched with a mixture of acetic acid, ammonium fluoride, and water. Insoluble crystals on the uncoated areas of the glass are clearly visible in FIG. 6 due to the presence of acetic acid in the etching solution. These crystals can contribute to a high-frequency texture on the glass substrate which may drive color shifting.

The glass substrate 200 comprising an array of discontinuous ink features 205 can be etched for a time sufficient to produce the convex light extraction features described above with reference to FIG. 2. The etching time may range, for example, from about 30 seconds to about 15 minutes, such as from about 1 minute to about 10 minutes, from about 2 minutes to about 8 minutes, or from about 3 minutes to about 5 minutes, including all ranges and subranges therebetween, and the etching may take place at room temperature or at elevated temperature. Process parameters such as acid concentration/ratio, temperature, and/or time may affect the size, shape, and distribution of the resulting extraction features. For instance, more concentrated etching solutions and/or longer etching times, to name a few parameters, may affect the amount of glass dissolved during the etching step and, thus, the height (or depth) h of the resulting light extraction features. It is within the ability of one skilled in the art to vary these parameters to achieve the desired surface extraction features.

During the etching process the discontinuous ink features may act as an etching shield, whereby the etching agent dissolves the non-ink covered portions of the glass substrate isotropically, e.g., equally in all directions, while the ink-covered portions remain substantially unaffected. When the ink is adequately adhered to the substrate, this process can result in the production of convex light extraction features. Ink-glass adhesion strength can, however, affect the height and/or profile of the light extraction features achieved in the aforementioned etching step.

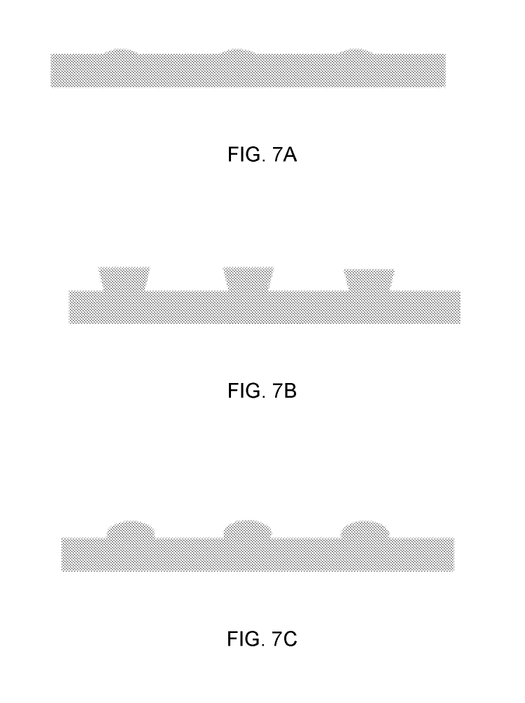

Referring to FIG. 7A, if the ink is weakly adhered to the glass substrate, the etching mask may peel off at the early stages of the etching process, resulting in light extraction features having a flattened profile. On the other hand, if the ink is too strongly adhered to the glass substrate, the resulting light extraction features may have the “top hat” profile illustrated in FIG. 7B. As illustrated in FIG. 7C, an ink that does not excessively or insufficiently adhere to the glass can be used to achieve a more rounded convex light extraction feature. According to various embodiments, the light extraction features have a substantially rounded convex profile, although other shapes and variations thereon are possible and envisioned as falling within the scope of the disclosure.

Following the etching step, the etched glass substrate 200 comprising an array of discontinuous ink features 205 can optionally be washed in order to remove the ink from the surface of the glass substrate. The resulting glass article illustrated in FIG. 5B can comprise an array of convex light extraction features 203 with a profile and properties substantially similar to the convex light extraction features 103a described with respect to FIG. 2.

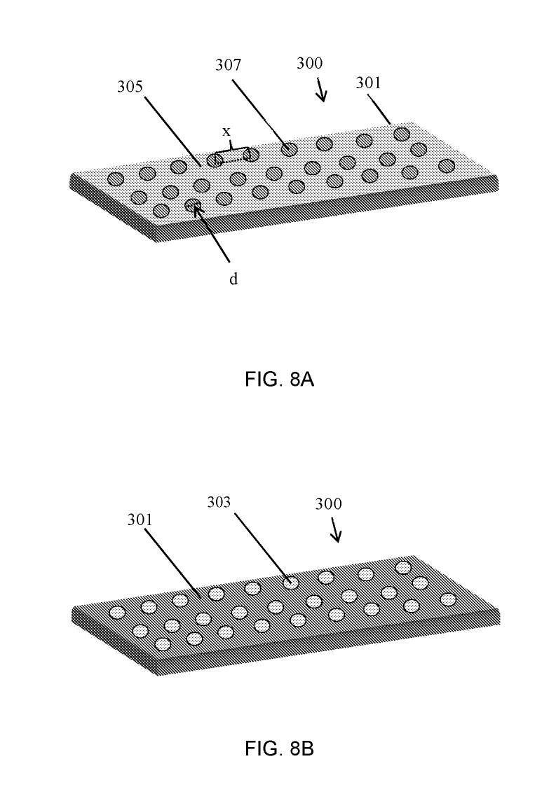

A second method for making a glass article comprising an array of concave light extraction features as depicted in FIG. 3, will be described with reference to FIGS. 8A-B. The method is substantially similar to the method for producing a glass article having an array of convex light extraction features discussed above with respect to FIGS. 5A-B and can comprise, for example, providing a glass substrate, optionally cleaning the glass substrate to remove surface contaminants, ink application, etching, and optionally washing of the ink from the surface. However, as illustrated in FIG. 8A, instead of applying ink to form discontinuous ink features, the ink can be applied to the first surface 301 of the glass substrate 300 to provide a continuous ink feature 305 and an array of discontinuous ink-free portions 307. The locations of these ink-free portions 307 can, for example, correspond with the concave light extraction features produced in the subsequent etching step. The discontinuous non-ink covered portions 307 can have dimensions substantially similar to the dimensions (d and x) of the discontinuous ink features 205 discussed above with respect to FIG. 5B.

After application of the continuous ink coating 305, the etching step can be carried out in a substantially similar manner to the etching step described above with respect to FIGS. 5A-B. However, because the ink shield now comprises a continuous ink feature 305 and the non-ink covered portions 307 comprise discontinuous rounded portions as described above, the etching agent can dissolve the non-ink covered discontinuous portions 307 while the continuous ink covered portion 305 remains substantially unaffected. This etching process can produce an array of light extraction features having a concave shape as defined herein. After the etching step is completed, the glass substrate can optionally be washed to remove ink from the surface of the glass substrate. As illustrated in FIG. 8B, the resulting glass article can comprise a first surface 301 comprising an array of concave light extraction features with a profile and properties substantially similar to the light extraction features 103b described above with respect to FIG. 3.

According to various non-limiting embodiments, the glass substrate may also be chemically strengthened, e.g., by ion exchange. During the ion exchange process, ions within a glass substrate at or near the surface of the glass substrate may be exchanged for larger metal ions, for example, from a salt bath. The incorporation of the larger ions into the glass can strengthen the substrate by creating a compressive stress in a near surface region. A corresponding tensile stress can be induced within a central region of the glass sheet to balance the compressive stress.

Ion exchange may be carried out, for example, by immersing the glass in a molten salt bath for a predetermined period of time. Exemplary salt baths include, but are not limited to, KNO₃, LiNO₃, NaNO₃, RbNO₃, and combinations thereof. The temperature of the molten salt bath and treatment time period can vary. It is within the ability of one skilled in the art to determine the time and temperature according to the desired application. By way of a non-limiting example, the temperature of the molten salt bath may range from about 400° C. to about 800° C., such as from about 400° C. to about 500° C., and the predetermined time period may range from about 4 to about 24 hours, such as from about 4 hours to about 10 hours, although other temperature and time combinations are envisioned. By way of a non-limiting example, the glass can be submerged in a KNO₃ bath, for example, at about 450° C. for about 6 hours to obtain a K-enriched layer which imparts a surface compressive stress.

The glass articles disclosed herein may be used in various display devices including, but not limited to LCDs or other displays used in the television, advertising, automotive, and other industries. For example, the glass article can be used as a light guide plate in a display device. Traditional backlight units used in LCDs can comprise various components. One or more light sources may be used, for example light-emitting diodes (LEDs) or cold cathode fluorescent lamps (CCFLs). Conventional LCDs may employ LEDs or CCFLs packaged with color converting phosphors to produce white light. According to various aspects of the disclosure, display devices employing the disclosed glass light guides may comprise at least one light source emitting blue light (UV light, approximately 100-400 nm), such as near-UV light (approximately 300-400 nm). The light guide plates and devices disclosed herein may also be used in any suitable lighting applications such as, but not limited to, luminaires or the like.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a light source” includes examples having two or more such light sources unless the context clearly indicates otherwise. Likewise, a “plurality” or an “array” is intended to denote “more than one.” As such, a “plurality of light extraction features” or “an array of light extraction features” includes two or more such features, such as three or more such features, etc.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a method that comprises A+B+C include embodiments where a method consists of A+B+C and embodiments where a method consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

1. A glass article comprising a first surface and an opposing second surface;
wherein the first surface comprises an array of light extraction features having a diameter of at least about 10 microns and a height ranging from about 1 micron to about 10 microns.

2. The glass article of claim 1, wherein the light extraction features are convex or concave.

3. The glass article of claim 2, wherein the convex or concave light extraction features are ellipsoidal, paraboloidal, hyperboloidal, or frusto-conical.

4. The glass article of claim 1, wherein the array of light extraction features is random, arranged, repetitive, non-repetitive, symmetrical or asymmetrical.

5. The glass article of claim 1, wherein the diameter of the light extraction features ranges from about 10 microns to about 700 microns.

6. The glass article of claim 1, wherein the light extraction features comprise a diameter to height ratio ranging from about 1:1 to about 10:1.

7. The glass article of claim 1, wherein the distance between the light extraction features ranges from about 5 microns to about 2 mm.

8. The glass article of claim 1, wherein the first surface of the glass article does not comprise light extraction features having a diameter of less than about 5 microns and a height of less than about 0.7 microns.

9. The glass article of claim 1, wherein a thickness of the glass article ranges from about 0.3 mm to about 3 mm.

10. The glass article of claim 1, wherein any one or combination of the heights, diameters, ratio of diameter to height, and geometries of the light extraction features vary as a function of position on the first surface.

11. A display device or luminaire comprising the glass article of claim 1.

12. A method for making a glass article comprising:
depositing ink on a first surface of a glass substrate to form an array of coated and uncoated surfaces; and
etching the uncoated surfaces to form a glass article having a first surface comprising an array of light extraction features having a diameter of at least about 10 microns and a height ranging from about 1 micron to about 10 microns.

13. The method of claim 12, wherein the coated surfaces comprise discontinuous ink features surrounded by uncoated surfaces.

14. The method of claim 12, wherein the uncoated surfaces comprise discontinuous features surfaces surrounded by coated surfaces.

15. The method of claim 12, wherein the array of light extraction features is random, arranged, repetitive, non-repetitive, symmetrical or asymmetrical.

16. The method of claim 12, wherein the diameter of the light extraction feature ranges from about 10 microns to about 30 microns.

17. The method of claim 12, wherein the light extraction features comprise a diameter to height ratio ranging from about 1:1 to about 10:1.

18. The method of claim 12, wherein the distance between the light extraction features ranges from about 5 microns to about 50 microns.

19. The method of claim 12, wherein any one or combination of the heights, diameters, ratio of diameter to height, and geometries of the light extraction features vary as a function of position on the first surface.

20. The method of claim 12, further comprising cleaning the glass substrate prior to depositing ink on the first surface of the glass substrate.

21. The method of claim 12, wherein etching comprises contacting the glass substrate with at least one etching agent.

22. The method of claim 12, wherein etching comprises immersing the glass substrate in an acid bath for a period of time ranging from about 30 seconds to about 15 minutes.

23. The method of claim 21, wherein the at least one etching agent is chosen from mineral acids.

24. The method of claim 21, wherein the at least one etching agent is not chosen from organic acids.

25. The method of claim 12, further comprising washing the glass substrate after etching to remove the ink from the first surface.
